(19) United States
(12) Patent Application Publication
(10) Pub. No.: US 2005/0086555 A1
(43) Pub. Date: Apr. 21, 2005

(54) Optical communications network

(76) Inventor: David Langridge, Stansted (GB)

Correspondence Address: BARNES & THORNBURG, P.O. BOX 2786, CHICAGO, IL, 60690-2786, US

(21) Appl. No.: 10/689,429

(22) Filed: Oct. 20, 2003

(51) Int. Cl. G06F 11/00

(52) U.S. Cl. 714/4

(57) ABSTRACT

An optical communications network uses tandem connection monitoring for monitoring errors introduced by a sub-network. The sub-network nodes are provided with a sub-network monitoring arrangement, and when the sub-network monitoring arrangement identifies a fault, an internal alarm indication indicative of a fault is provided as the error information. The tandem connection monitoring arrangement, upon receipt of data with the internal alarm indication, replaces the internal alarm indication with a general fault indication. The network of the invention has two levels of alarm indication. One is for identifying a fault in a preceding sub-network, and the other is for identifying a fault internal to a TCM monitoring section. This enables path alarm flooding to be avoided.

### FIELD OF THE INVENTION

This invention relates to optical communications networks, in particular networks in which tandem connection monitoring is employed.

### BACKGROUND OF THE INVENTION

Large optical networks typically have different sections provided by different network operators. For example, a regional urban network operator may operate locally, and these local networks are connected together by a network operated by a larger network operator. As a result, optical network connections between users are typically routed via networks of different operators.

Each operator will provide services according to their own “service level agreement”, and each operator is thus responsible for monitoring the performance of their network in order to ensure an agreed quality of service is met. Furthermore, any faults must then be corrected within a specific time span.

There is therefore a need within optical networks to determine at which part of the network errors are being introduced.

One common optical network technology is SONET/SDH. In SONET/SDH systems, a signal at the edge of the network is mapped into a SONET/SDH path, known as a “virtual container” (VC). The signal is given a “path overhead” which includes a bit interleaved parity byte for error detection and correction purposes. Paths are multiplexed together and given a multiplexer section overhead (“line overhead” in SONET). This overhead includes pointers to the path overheads.

If a fault, such as a fiber cut, occurs then the receiving add drop multiplexer (ADM) or cross-connect will normally send a path-AIS (alarm indication signal) in all the corrupted payloads. This path AIS is all 1's in the data and in the pointers. This signifies to the path terminating equipment at the other end that the path has been lost. SONET and SDH technologies provide a system known as tandem connection monitoring (TCM) to allow the performance of different sub-networks to be monitored, with the different sub-networks together defining the complete path between the end users.

This system uses the parity byte to enable any bit errors that occur to be assigned to a particular section of the network. In particular, this error check uses the B3 byte (an 8 bit word) or the V5 byte (a 2 bit word) to monitor errors over the TCM section within the network.

In the case of the 8 bit B3 parity byte, the data is arranged in a table having 8 columns, and the parity byte is used to give all of these columns of data an even number of 1's. If at any point in the network the parity byte no longer matches the columns of data, then an error has occurred. Up to 8 errors can be recorded in this way.

FIG. 1 is used to show how the TCM system makes it possible to determine which network operator is responsible for any errors that arise.

FIG. 1 shows a source node 10 and a sink node 12, which form part of a first network operator system 14. The path between the source and sink nodes 10, 12 also passes through a sub-network 16 of a different network operator. The traffic between the nodes 10, 12 can, of course, be bi-directional, as shown in FIG. 1. Thus, the sink node 12 also has a data source 12a, and the source node 10 also has a data sink 10a.

At the transition from the first network 14 to the second network 16, a tandem connection monitoring arrangement is provided. For the data path from the source node 10 to the sink node 12, a TCM source 20 is provided at the interface from the first network 14 to the second network 16, and a TCM sink 22 is provided at the interface from the second network 16 to the first network 14. These together define a tandem connection monitoring arrangement for monitoring errors introduced by the sub-network 16. The TCM section thus covers sub-network 16.

The operation of the TCM arrangement is to compare an incoming parity byte with a parity byte computed based on the data received by the network 16. The comparison result is in the form of a so-called “incoming error count” and is transferred using an allocated byte to the end of the TCM section, namely to the TCM sink 22. Thus, the TCM system relays comparison data rather than parity data.

In the SONET and SDH systems, there are two bytes which can be used for providing this TCM comparison information. These are the so-called N1 byte and the so-called N2 byte. The N1 byte is used when the 8 bit B3 parity byte is employed. In the following detailed description, the operation of a TCM system will be explained further assuming use of the N1 byte for transmitting information between the TCM source and sink, and this assumes use of the 8 bit B3 parity byte. Those skilled in the art will know that this system is used for VC-3 and VC-4 data container configurations.

At the end of the TCM section, namely at the TCM sink 22, there is another check of the parity byte, and a further comparison with the content of the N1 byte (which gives the result of the comparison at the TCM source). If the difference is equal to zero, then the operator of network 16 is not responsible for any errors that have occurred. If there is a difference in the results of the parity byte checks at the TCM source and sink, then errors have been introduced in the TCM section, and the number of errors added by the monitored section can be determined.

The N1 byte comprises an 8 bit word, which is used to perform a number of functions in addition to recording error comparisons. Four of the bits of the 8 bit N1 byte are used for the incoming error count (IEC). Only these bits of the N1 byte are relevant to this invention, and the use of these 4 bits is explained in further detail with reference to FIG. 2

FIG. 2 shows how the 4 IEC bits of the N1 byte are interpreted.

As shown, nine different combinations of bits are used to represent a number of bit interleaved parity (BIP) violations from zero to 8. An additional combination of the bits is used to represent an incoming alarm indication signal (AIS). This is used to represent a complete path failure within the network. The values 1 to 8 and 14 are used, a value of 0 is not used, and values 9 to 13 and 15 are reserved for future standardisation.

If path AIS is detected at the input to the TCM section (because a fault has occurred before the TCM section), the pointer is changed from all 1's to a valid pointer. This pointer points to a path overhead with a correct parity byte B3 generated by the TCM source function and giving zero errors. Furthermore, a code 1110 is provided in the IEC bits. This signal looks like a valid path to the Network Elements that the path traverses. Thus, monitoring of the TCM section can continue.

If the IEC code 1110 is detected at the TCM sink, the errors are still computed, as if the IEC=0, but path AIS is sent onwards (all 1's in the pointer and data). As the B3 byte was set to give zero errors at the TCM source, the total number of errors computed must have been generated within the monitored section. Receipt at the TCM sink of the 1110 AIS means that the alarm signal relates to a fault before the TCM section.

When a fault occur within the TCM section, the next SONET/SDH Network Element will insert path AIS. This will be detected at the TCM sink which will thus recognise that the monitored section has failed, and path AIS will continue onwards.

When path AIS is detected by a node, a path alarm signal is sent to the network management center. Thus, when path AIS is generated within a TCM section, an alarm is generated by each node with the TCM section through which the path AIS travels.

A problem encountered in networks relates to the propagation of path alarms through the network. This can cause a flood of alarms for a single fault in the network.

Furthermore, automatic protection and restoration methods (for example ASTN-ITU-T G.807) rely on identifying the location of a fault. These path AIS signals do not identify the first switching point at which the path had failed, making automatic protection and restoration complicated.

The invention aims to use the TCM system to enable the location of faults to be identified, and to prevent multiple path alarm signals being generated.

### SUMMARY OF THE INVENTION

According to a first aspect of the invention, there is provided an optical communications network, comprising:
a source node and a sink node;
a sub-network comprising a plurality of sub-network nodes, the sub-network being provided in a path between the source node and the sink node;
a tandem connection monitoring arrangement provided at first and second edges of the sub-network for monitoring errors introduced by the sub-network, wherein the tandem connection monitoring arrangement at the first edge provides error information with the optical data passing through the sub-network, wherein the error information includes an error count or a first alarm indication indicative of an incoming fault,
wherein at least one of the sub-network nodes is provided with a sub-network monitoring arrangement, wherein when the sub-network monitoring arrangement identifies a fault, a second alarm indication indicative of a fault is provided as the error information, and wherein the tandem connection monitoring arrangement at the second edge, upon receipt of the second alarm indication, replaces the second alarm indication with a fault indication.

The network of the invention provides two levels of alarm indication. The “first alarm indication” is used to signify the existence of a fault in the preceding sub-network. However, for faults within the sub-network, a “second alarm indication” is used. This enables faults occurring within the sub-network to be notified differently.

For example, when a second alarm indication is provided, an alarm message can be provided to the network control center. However, when data is received already having this second alarm indication, no alarm message is then provided to the network control center. This then avoids multiple alarm signals being generated.

The “fault indication” provided by the TCM sink is preferably the standard path AIS indication.

The network preferably comprises a SONET or SDH network, and the error information preferably comprises bit interleaved parity violation information or an incoming alarm indication signal.

According to a second aspect of the invention, there is provided a method of monitoring errors in an optical communications network, comprising a source node and a sink node, and having a sub-network comprising a plurality of sub-network nodes provided in a path between the source node and the sink node, the method comprising:
providing error information with optical data to be passed through the sub-network at a tandem connection monitoring arrangement at a first edge of the sub-network, the error information including an error count or a first alarm indication indicative of a fault;
at a sub-network node, monitoring receipt of the optical data, and when a fault is identified, providing a second alarm indication indicative of the fault as the error information; and
at a tandem connection monitoring arrangement at a second edge of the sub-network, upon receipt of the second alarm indication, replacing the second alarm indication with a fault indication.

This method provides operation of the network of the invention.

According to a third aspect of the invention, there is provided an optical packet structure for use in an optical network in which a tandem connection monitoring arrangement provided at first and second edges of a sub-network for monitoring errors introduced by the sub-network, the packet structure comprising an optical header and an optical data payload, wherein the header comprises a tandem connection monitoring byte which includes a plurality of incoming error counter bits, wherein the incoming error counter bits can be set to: a first series of values which represent different numbers of errors; a second value representing a first alarm signal indicating a fault external to the sub-network; and a third value representing a second alarm signal indicating a fault internal to the sub-network.

According to a fourth aspect of the invention, there is provided a computer readable medium carrying instructions for controlling nodes of an optical communications network comprising a source node and a sink node, and having a sub-network comprising a plurality of sub-network nodes provided in a path between the source node and the sink node, the instructions implementing a method comprising:
providing error information with optical data to be passed through the sub-network at a tandem connection monitoring arrangement at a first edge of the sub-network, the error information including an error count or a first alarm indication indicative of a fault;
at a sub-network node, monitoring receipt of the optical data, and when a fault is identified, providing a second alarm indication indicative of the fault as the error information; and
at a tandem connection monitoring arrangement at a second edge of the sub-network, upon receipt of the second alarm indication, replacing the second alarm indication with a fault indication.

This software is preferably used to operate a network control centre which implements the tandem connection monitoring method of the invention.

### BRIEF DESCRIPTION OF THE DRAWINGS

An example of the invention will now be described in detail with reference to the accompanying drawings, in which:

FIG. 1 shows a known network configuration using tandem connection monitoring;

FIG. 2 shows the known use of 4 of the 8 bits of the N1 byte to provide an incoming error count;

FIG. 3 shows one example of the use of the 4 bits of FIG. 2 for error monitoring of the invention; and

FIG. 4 is a network diagram for explaining the operation of the network of the invention.

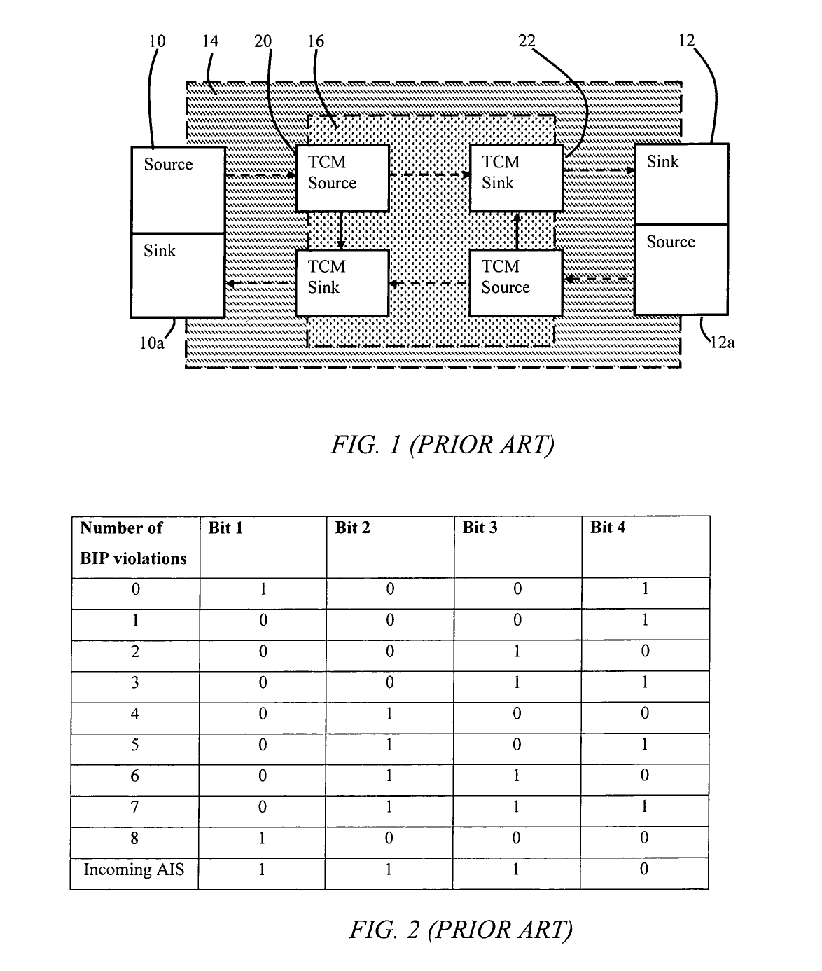

### DETAILED DESCRIPTION

The invention provides monitoring at individual nodes within a TCM section, for identifying a fault. If a fault is detected, a new second alarm indication is provided, which is arranged to prevent path alarm flooding. This is replaced with the conventional path AIS at the sink node of the TCM monitoring arrangement.

Thus, two levels of alarm indication are provided. One is for indicating a fault in a preceding sub-network. Within the sub-network, the second alarm indication, representing an internal fault, enables faults occurring within the sub-network to be notified differently. The conventional path AIS is used at the end of the TCM region, so that the existence of a fault is relayed by the TCM sink in conventional manner. Thus, no modification of equipment downstream of the TCM section is required.

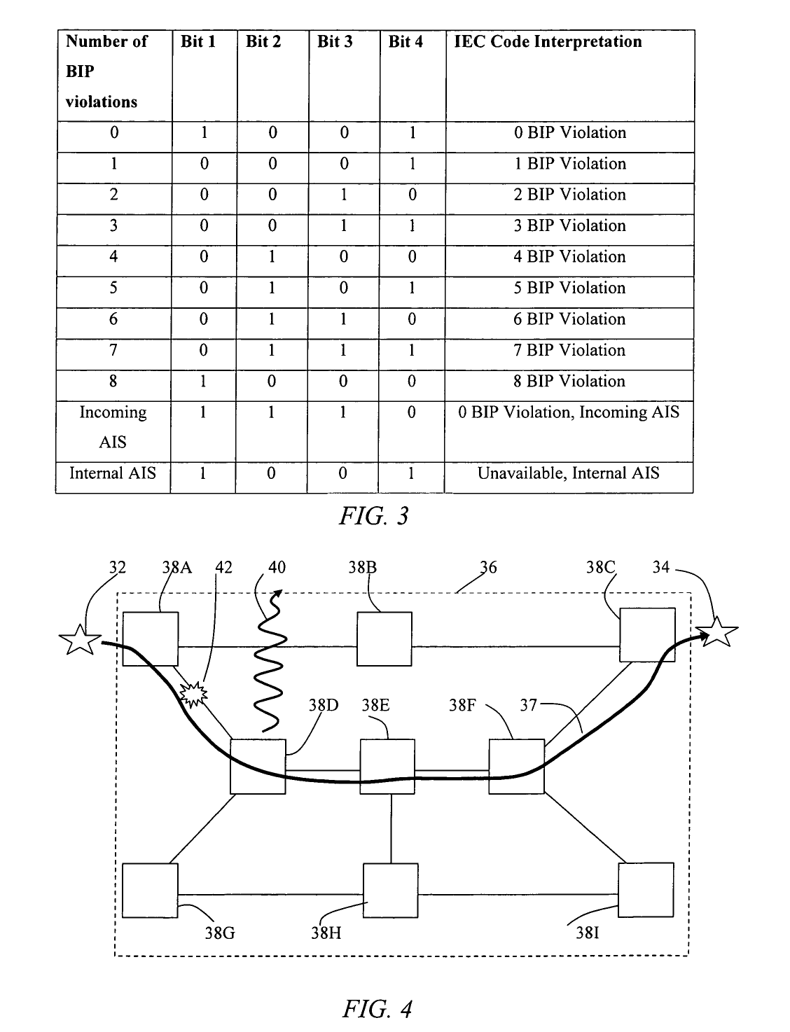

FIG. 3 shows how the invention may be implemented using one of the reserved bit combinations of the four IEC bits of the N1 byte.

As shown, a new “Internal AIS” alarm indicator is given value 9 (although any of the other available values could be used).

FIG. 3 also shows how the IEC bits are interpreted at the TCM sink. The IEC bits representing 0 to 8 BIP violations are clearly interpreted accordingly. When the incoming AIS signal is received, this informs the TCM sink that path AIS was received by the TCM source, but also indicates that the B3 parity byte was set at the TCM source with no internal BIP violations. When the “internal AIS” signal of the invention is received, the error monitoring process at the TCM sink understands that the tandem connection is unavailable. This is the same interpretation currently given for receipt of path AIS.

FIG. 4 is used to explain how the additional error message is used in accordance with the invention.

FIG. 4 shows an optical communications network 30, comprising a source node 32 and a sink node 34. Between these two nodes, a sub-network 36 is provided which is formed of sub-network nodes 38A-38I. The sub-network 36 is provided in a path 37 between the source node 32 and the sink node 34, and is typically operated by a different organisation to other parts of the network (not shown in FIG. 4).

A tandem connection monitoring arrangement is provided at the edges of the sub-network 36, for example a TCM source at node 38A and a TCM sink at node 38C. This TCM arrangement is for monitoring errors introduced by the sub-network 36, in conventional manner. Thus, the tandem connection monitoring arrangement inserts error information into a header (in particular the N1 byte as described above) of the optical data passing through the sub-network 36, and this error information includes an error count, for example based on a comparison of the B3 parity byte with the optical data.

The invention adds intermediate monitoring points within the TCM section, for example at nodes 38D, 38E and 38F. Each of the intermediate points monitors the connection for faults. If a path fault is detected, or another fault that would normally result in a path AIS signal to be inserted, then an alarm is raised at that intermediate node, for example as shown by arrow 40. The fault is shown as 42.

When a conventional path AIS signal is inserted, an invalid pointer is generated. In the system of the invention, a valid path overhead and pointer is generated, as well as data (for example all 1's). A new code, the “Internal AIS” of FIG. 3, is then provided as the IEC data. This indicates that a fault has occurred within the TCM section, but also prevents downstream monitoring points raising alarms, as a valid path overhead and pointer are present.

The invention thus enables the network management control center and/or the control plane for ASTN, which receives the path alarm 40, to determine immediately in which span the failure has taken place. This simplifies the implementation of a protection scheme and also simplifies the maintenance operation.

At the tandem connection sink 38C, the reception of the “Internal AIS” causes a standard path AIS signal (all 1's in the data and pointers) to be transmitted from the TCM sink. Thus, the behaviour of all components downstream of the TCM sink 38C is unaffected by the modification provided by the invention.

The failure detection capability provided in the nodes 38D-38F will be the conventional monitoring circuitry. Each node will also have the hardware to enable the codes to be introduced into the IEC bits, and the invention can thus be implemented by minor modification to the network management software to enable the functionality provided by the invention.

When a failure is present before the TCM section, a path AIS signal will be received at the TCM source. This will be handled in conventional manner. Thus, a valid pointer and path overhead are inserted, and the B3 byte is set to give zero errors. The IEC bits have value 1110. The invention still enables the location of a fault within the TCM section to be determined, as when such a fault is detected, the corrupted path is replaced with a valid path overhead and pointer and IEC 1001, and an alarm is generated. As described above, the path AIS is provided by the TCM sink, so that downstream parts of the network are not affected by the invention.

The invention requires only slight modification to the N1 byte definition (which functions as a tandem connection monitoring byte) by providing one value representing a first alarm signal, which indicates a fault external to the sub-network, and another value representing a second alarm signal indicating a fault internal to the sub-network being monitored by the TCM section.

The invention has been described in detail as a modification to the N1 byte used for B3 parity byte comparison within a SONET/SDH network. The invention can, however, be applied to other TCM applications.

Further modifications will be apparent to those skilled in the art.

1. An optical communications network, comprising:
a source node and a sink node;
a sub-network comprising a plurality of sub-network nodes, the sub-network being provided in a path between the source node and the sink node;
a tandem connection monitoring arrangement provided at first and second edges of the sub-network for monitoring errors introduced by the sub-network, wherein the tandem connection monitoring arrangement at the first edge provides error information with the optical data passing through the sub-network, wherein the error information includes an error count or a first alarm indication indicative of an incoming fault,
wherein at least one of the sub-network nodes is provided with a sub-network monitoring arrangement, wherein when the sub-network monitoring arrangement identifies a fault, a second alarm indication indicative of a fault is provided as the error information, and wherein the tandem connection monitoring arrangement at the second edge, upon receipt of the second alarm indication, replaces the second alarm indication with a fault indication.

2. A network as claimed in claim 1, wherein when a sub-network monitoring arrangement provides a second alarm indication, an alarm message is provided to a network control centre.

3. A network as claimed in claim 2, wherein when a sub-network monitoring arrangement receives data already having a second alarm indication, no alarm message is provided to the network control centre.

4. A network as claimed in claim 1, wherein the error information comprises bit interleaved parity violation information or an incoming alarm indication signal.

5. A network as claimed in claim 1, comprising a SONET or SDH network.

6. A network as claimed in claim 5, wherein the tandem connection monitoring arrangement inserts error information into the N1 or N2 byte.

7. A network as claimed in claim 6, wherein the tandem connection monitoring arrangement inserts error information into the IEC bits of the N1 byte.

8. A method of monitoring errors in an optical communications network, comprising a source node and a sink node, and having a sub-network comprising a plurality of sub-network nodes provided in a path between the source node and the sink node, the method comprising:
providing error information with optical data to be passed through the sub-network at a tandem connection monitoring arrangement at a first edge of the sub-network, the error information including an error count or a first alarm indication indicative of a fault;
at a sub-network node, monitoring receipt of the optical data, and when a fault is identified, providing a second alarm indication indicative of the fault as the error information; and
at a tandem connection monitoring arrangement at a second edge of the sub-network, upon receipt of the second alarm indication, replacing the second alarm indication with a fault indication.

9. A method as claimed in claim 8, wherein when a second alarm indication is provided, an alarm message is provided to a network control centre.

10. A method as claimed in claim 9, wherein when a sub-network node receives a header already having a second alarm indication, no alarm message is provided to the network control centre.

11. A method as claimed in claim 8, wherein the error information comprises bit interleaved parity violation information or an incoming alarm indication signal.

12. A method as claimed in claim 8, wherein the network comprises a SONET or SDH network.

13. A method as claimed in claim 12, wherein the error information is inserted into the N1 or N2 byte.

14. A method as claimed in claim 13, wherein the error information is inserted into the IEC bits of the N1 byte.

15. A optical packet structure for use in an optical network in which a tandem connection monitoring arrangement provided at first and second edges of a sub-network for monitoring errors introduced by the sub-network, the packet structure comprising an optical header and an optical data payload, wherein the header comprises a tandem connection monitoring byte which includes a plurality of incoming error counter bits, wherein the incoming error counter bits can be set to:
a first series of values which represent different numbers of errors;
a second value representing a first alarm signal indicating a fault external to the sub-network; and
a third value representing a second alarm signal indicating a fault internal to the sub-network.

16. An optical packet structure as claimed in claim 15, wherein the tandem connection monitoring byte comprises the SONET or SDH N1 or N2 byte.

17. A computer readable medium carrying instructions for controlling nodes of an optical communications network comprising a source node and a sink node, and having a sub-network comprising a plurality of sub-network nodes provided in a path between the source node and the sink node, the instructions implementing a method comprising:
providing error information with optical data to be passed through the sub-network at a tandem connection monitoring arrangement at a first edge of the sub-network, the error information including an error count or a first alarm indication indicative of a fault;
at a sub-network node, monitoring receipt of the optical data, and when a fault is identified, providing a second alarm indication indicative of the fault as the error information; and
at a tandem connection monitoring arrangement at a second edge of the sub-network, upon receipt of the second alarm indication, replacing the second alarm indication with a fault indication.
